(19) United States
(12) Patent Application Publication
(10) Pub. No.: US 2013/0057397 A1
(43) Pub. Date: Mar. 7, 2013

(54) METHOD OF OPERATING A VEHICLE SAFETY SYSTEM

(71) Applicants: Daniel B. Cutler, Novi, MI (US); Chad T. Zagorski, Clarkston, MI (US); Aamrapali Chatterjee, Okemos, MI (US)

(72) Inventors: Daniel B. Cutler, Novi, MI (US); Chad T. Zagorski, Clarkston, MI (US); Aamrapali Chatterjee, Okemos, MI (US)

(73) Assignee: GM GLOBAL TECHNOLOGY OPERATIONS LLC, Detroit, MI (US)

(21) Appl. No.: 13/223,684

(22) Filed: Sep. 1, 2011

(51) Int. Cl. B60Q 1/00; G05D 1/02

(52) U.S. Cl. 340/435; 701/25

(57) ABSTRACT

A vehicle safety system and method that may be used to detect a potential tailgating event involving another vehicle and to send a corresponding warning to the driver. In an exemplary embodiment, the vehicle safety system monitors the area behind the host vehicle when it is being driven in the forward direction and determines if the host vehicle is being tailgated by a target vehicle. If such a tailgating event is detected, then the vehicle safety system sends a corresponding warning to the driver and, according to an optional feature, checks the availability of an adjacent lane so that the system can perform an automatic lane change maneuver, if so authorized.

### TECHNICAL FIELD

The present invention generally relates to vehicle systems and, more particularly, to vehicle safety systems that assist the driver in situations where the vehicle is being followed closely or tailgated by another vehicle.

### BACKGROUND

A driver in a host vehicle may not be aware that another target vehicle is following them at a close and unsafe distance; a situation sometimes referred to as “tailgating.” As a result, the driver of the host vehicle may continue to travel in their lane, unaware that the target vehicle is tailgating them at a close proximity that creates a potentially dangerous situation. The method and system described herein are designed to address this type of situation.

### SUMMARY

According to one embodiment, there is provided a method for use with a vehicle safety system. The method may comprises the steps of: (a) providing a vehicle safety system having one or more sensing device(s) for installation on a host vehicle; (b) monitoring an area behind the host vehicle with the sensing device(s) while the host vehicle is being driven in a forward direction; (c) detecting a target vehicle in the area behind the host vehicle with the sensing device(s) while the host vehicle is being driven in the forward direction, and determining a tailway distance between the target vehicle and the host vehicle; and (d) evaluating the tailway distance between the target vehicle and the host vehicle, and alerting an operator inside of the host vehicle when the target vehicle is too close.

According to another embodiment, there is provided a method for use with a vehicle safety system. The method may comprise the steps of: (a) determining if a target vehicle is tailgating a host vehicle while the host vehicle is being driven in a forward direction; (b) alerting an operator that the target vehicle is tailgating the host vehicle; (c) determining if a lane change is appropriate; and (d) if the lane change is appropriate, then requesting that the operator make a lane change or performing an automatic lane change maneuver where the host vehicle is guided from a current lane to an adjacent lane.

### DRAWINGS

Preferred exemplary embodiments will hereinafter be described in conjunction with the appended drawings, wherein like designations denote like elements, and wherein:

FIG. 1 is a schematic view of a host vehicle and a target vehicle, where the host vehicle has an exemplary vehicle safety system; and

FIG. 2 is a flowchart illustrating an exemplary method for use with a vehicle safety system, such as the one shown in FIG. 1.

### DESCRIPTION

The vehicle safety system and method described herein may be used to detect a potential tailgating event involving another vehicle and to send a corresponding warning to the driver. In an exemplary embodiment, the vehicle safety system monitors the area behind the host vehicle when it is being driven in the forward direction and determines if the host vehicle is being tailgated by a target vehicle. If such a tailgating event is detected, then the vehicle safety system sends a corresponding warning to the driver and, according to an optional feature, checks the availability of an adjacent lane so that the system can perform an automatic lane change maneuver, if so authorized.

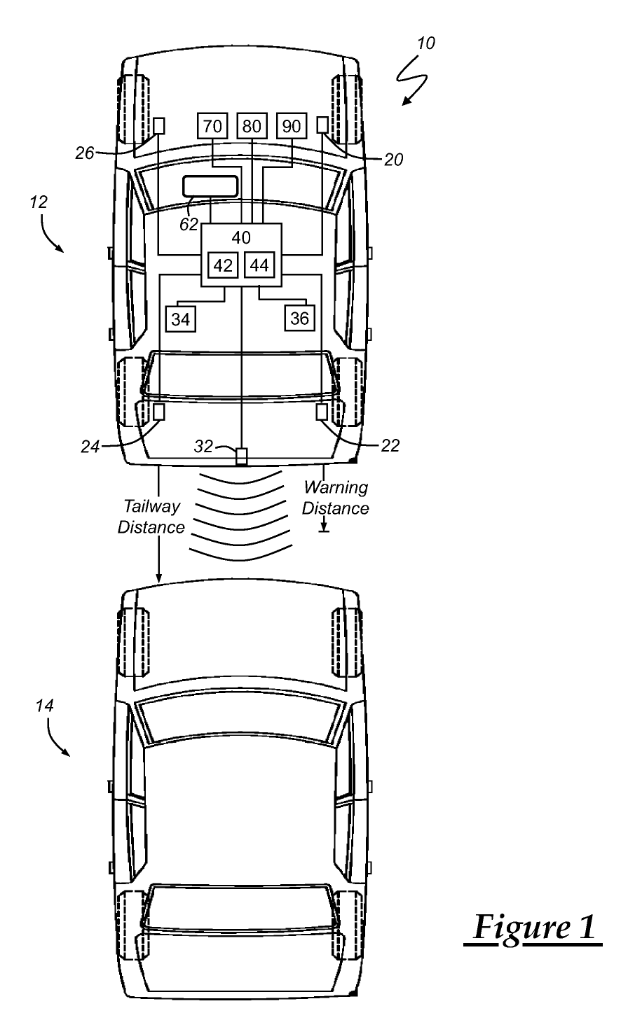

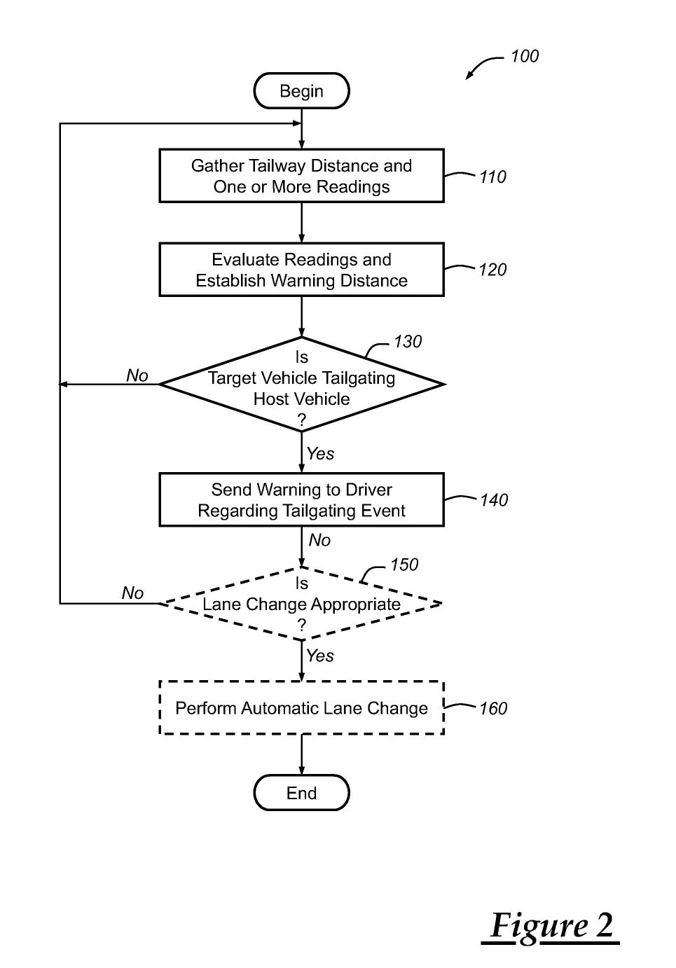

With reference to FIG. 1, there is shown a general and schematic view of an exemplary vehicle safety system 10 installed on a host vehicle 12, where the safety system may detect and/or evaluate a target vehicle 14 when the target vehicle is being driven closely behind the host vehicle in a forward direction. It should be appreciated that the present system and method may be used with any type of vehicle, including traditional vehicles, hybrid electric vehicles (HEVs), extended-range electric vehicles (EREVs), battery electrical vehicles (BEVs), motorcycles, passenger vehicles, sports utility vehicles (SUVs), cross-over vehicles, trucks, vans, buses, recreational vehicles (RVs), etc. These are merely some of the possible applications, as the system and method described herein are not limited to the exemplary embodiments shown in FIGS. 1-2 and could be implemented in any number of different ways. According to one example, vehicle safety system 10 includes host vehicle sensors 20-26, target vehicle sensor 32, environmental sensor 34, navigation module 36, control module 40 and user interface 62, and is designed to interact with engine control module 70, brake module 80 and/or steering control module 90.

Any number of different sensors, components, devices, modules, systems, etc. may provide vehicle safety system 10 with information or input that can be used by the present method. These include, for example, the exemplary sensors shown in FIG. 1, as well as other sensors that are known in the art but are not shown here. It should be appreciated that host vehicle sensors 20-26, target vehicle sensor 32, environmental sensor 34, as well as any other sensor located in and/or used by vehicle safety system 10 may be embodied in hardware, software, firmware or some combination thereof. These sensors may directly sense or measure the conditions for which they are provided, or they may indirectly evaluate such conditions based on information provided by other sensors, components, devices, modules, systems, etc. Furthermore, these sensors may be directly coupled to control module 40, indirectly coupled via other electronic devices, a vehicle communications bus, network, etc., or coupled according to some other arrangement known in the art. These sensors may be integrated within another vehicle component, device, module, system, etc. (e.g., sensors that are already a part of an engine control module (ECM), traction control system (TCS), electronic stability control (ESC) system, antilock brake system (ABS), etc.), they may be stand-alone components (as schematically shown in FIG. 1), or they may be provided according to some other arrangement. It is possible for any of the various sensor readings described below to be provided by some other component, device, module, system, etc. in host vehicle 12 instead of being directly provided by an actual sensor element. In some instances, multiple sensors might be employed to sense a single parameter (e.g., for providing redundancy). It should be appreciated that the foregoing scenarios represent only some of the possibilities, as any type of suitable sensor arrangement may be used by vehicle safety system 10. That system is not limited to any particular sensor or sensor arrangement.

Host vehicle sensors 20-26 provide vehicle safety system 10 with host vehicle readings or other information that may be used to detect and/or evaluate a potential tailgating event. In one embodiment, host vehicle sensors 20-26 generate readings that are representative of the position, velocity and/or acceleration of host vehicle 12. Some examples of such readings include a host vehicle velocity reading (v_{HOST}) and a host vehicle acceleration reading (a_{HOST}). Host vehicle sensors 20-26 may utilize a variety of different sensors and sensing techniques, including those that use rotational wheel speed, ground speed, accelerator pedal position, gear shifter selection, accelerometers, engine speed, engine output, and throttle valve position, to name a few. In the example shown in FIG. 1, individual wheel speed sensors 20-26 are coupled to each of the host vehicle's four wheels and separately report the rotational velocity of the four wheels. Skilled artisans will appreciate that these sensors may operate according to optical, electromagnetic or other technologies, and that other parameters may be derived or calculated from the velocity readings, such as vehicle acceleration. In another embodiment, host vehicle sensors 20-26 determine vehicle speed relative to the ground by directing radar, laser and/or other signals towards the ground and analyzing the reflected signals, or by employing feedback from a navigation module 36 that has Global Positioning System (GPS) capabilities. As mentioned above, host vehicle sensors 20-26 may be part of some other device, module, system, etc., like an anti-lock braking system (ABS).

Target vehicle sensor 32 provides vehicle safety system 10 with target vehicle readings or other information that may be used to detect and/or evaluate a potential tailgating event. In one embodiment, target vehicle sensor 32 generates readings or data that are representative of the position, velocity and/or acceleration of target vehicle 14. These readings may be absolute in nature (e.g., a target vehicle velocity reading (v_{TAR}) or a target vehicle acceleration reading (a_{TAR}) that is relative to ground) or they may be relative in nature (e.g., a relative velocity reading (Δv) which is the difference between target and host vehicle velocities, or a relative acceleration reading (Δa) which is the difference between target and host vehicle accelerations). According to one example, target vehicle sensor 32 is mounted near the rear of host vehicle 12 and provides vehicle safety system 10 with the following inputs: a relative velocity reading (Δv), an actual target vehicle acceleration reading (a_{TAR}), and a relative distance reading (Δd) which is the range or distance between the target and host vehicles and is also referred to as the tailway distance. Sensor 32 may be a single sensor or a combination of sensors, and may include a light detection and ranging (LIDAR) device, radio detection and ranging (RADAR) device, vision device (e.g., camera, etc.), a vehicle-to-vehicle communication device, or a combination thereof. According to an exemplary embodiment, sensor 32 includes a rearward-looking short-range RADAR device that is mounted on the back of the vehicle, such as at the back bumper. A camera may be used in conjunction with the target vehicle sensor 32. In one embodiment, the short-range RADAR device and/or the camera are part of an existing vehicle backup system and can monitor the area behind the host vehicle while the host vehicle is being driven in the forward direction. Vehicle safety system 10 is not limited to any particular type of sensor or sensor arrangement, specific technique for gathering or processing sensor readings, or particular method for providing sensor readings, as the embodiments described herein are simply meant to be exemplary.

Environmental sensor 34 provides vehicle safety system 10 with one or more outside or environmental readings that may be used to detect and/or evaluate current environmental conditions that may affect the vehicle. For example, environmental sensor 34 may include an outside temperature sensor, an outside humidity sensor, a precipitation sensor, or any other type of sensor that senses or gathers environmental readings. The outside temperature sensor may sense ambient air temperatures, and may do so in any number of different ways. Some examples of how environmental sensor 34 may determine environmental conditions include directly sensing and measuring environmental readings, indirectly determining environmental readings by gathering them from other modules or systems in the vehicle, or by receiving wireless transmissions that include weather reports, forecasts, etc. from a weather-related service or website. In the last example, the wireless transmissions may be received at a telematics unit which then conveys the pertinent environmental data to control module 40. Other examples of environmental sensors are possible as well. As illustrated in the exemplary embodiment of FIG. 1, environmental sensor 34 may be mounted to the host vehicle and be coupled to control module 40 through suitable communication means.

Navigation module 36 uses the current position of the vehicle to provide a variety of navigation-related services, including services and information provided to vehicle safety system 10. Depending on the particular embodiment, navigation module 36 may be a stand-alone component or it may be integrated within some other component or system within the vehicle. The navigation module may include any combination of other components, devices, modules, etc., like a telematics unit or a GPS unit, and may use the current position of the vehicle and road- or map-data to evaluate the upcoming road. For instance, navigation module 36 may evaluate and determine the number of lanes in a road where vehicle 12 is currently being driven, it may evaluate the status of the road (e.g., is there a lane closure, road construction, heavy traffic ahead, etc.), it may determine if there is an abrupt change in the road (e.g., fork in the road ahead, sharp turn, etc.). This type of navigation-related information may be provided to control module 40 so that it can be taken into account by the present method, as will be explained in more detail. It is also possible for navigation module 36 to have some type of user interface so that information can be verbally, visually or otherwise exchanged between the navigation module and the driver.

Control module 40 may include any variety of electronic processing devices, memory devices, input/output (I/O) devices, and/or other known components, and may perform various control and/or communication related functions. In an exemplary embodiment, control module 40 includes an electronic memory device 42 that stores various sensor readings (e.g., sensor readings from sensors 20-26 and 32-36), look up tables or other data structures, algorithms (e.g., the algorithm embodied in the exemplary method described below), etc. Memory device 42 may also store pertinent characteristics and background information pertaining to vehicle 12, such as information relating to stopping distances, deceleration limits, temperature limits, moisture or precipitation limits, driving habits or other driver behavioral data, etc. Control module 40 may also include an electronic processing device 44 (e.g., a microprocessor, a microcontroller, an application specific integrated circuit (ASIC), etc.) that executes instructions for software, firmware, programs, algorithms, scripts, etc. that are stored in memory device 42 and may govern the processes and methods described herein. Control module 40 may be electronically connected to other vehicle devices, modules and systems via suitable vehicle communications and can interact with them when required. These are, of course, only some of the possible arrangements, functions and capabilities of control module 40, as other embodiments could also be used.

Depending on the particular embodiment, control module 40 may be a stand-alone vehicle electronic module (e.g., an object detection controller, a safety controller, etc.), it may be incorporated or included within another vehicle electronic module (e.g., a park assist control module, brake control module, steering control module, etc.), or it may be part of a larger network or system (e.g., a traction control system (TCS), electronic stability control (ESC) system, antilock brake system (ABS), driver assistance system, adaptive cruise control system, lane departure warning system, etc.), to name a few possibilities. Control module 40 is not limited to any one particular embodiment or arrangement.

User interface 62 exchanges information or data with occupants of the vehicle and may include any combination of visual, audio and/or other types of components for doing so. Depending on the particular embodiment, user interface 62 may be an input/output device that can both receive information from and provide information to the driver (e.g., a touch-screen display or a voice-recognition human-machine interface (HMI)), an input device only (e.g., a microphone), an output device only (e.g., a speaker, an instrument panel gauge, or a visual indicator on the rear-view mirror), or some other component. User interface 62 may be a stand-alone module; it may be part of a rear-view mirror assembly, it may be part of an infotainment system or part of some other module, device or system in the vehicle; it may be mounted on a dashboard (e.g., with a driver information center (DIC)); it may be projected onto a windshield (e.g., with a heads-up display); or it may be integrated within an existing audio system, to cite a few examples. In the exemplary embodiment shown in FIG. 1, user interface 62 is incorporated within a rear view mirror assembly and alerts a driver of a tailgating situation by illuminating a safety icon or the like, however, other embodiments are certainly possible. For instance, the user interface may include some type of video display monitor or screen located on the rear view mirror assembly, the instrument panel or elsewhere, where the display receives video signals from a camera that is part of sensor 32 and displays them to the driver. Other suitable user interfaces may be used as well.

It should be appreciated that engine control module 70, brake module 80, and steering module 90 may be embodied in hardware, software, firmware or some combination thereof. Depending on the particular embodiment, these modules may be stand-alone components (as schematically illustrated in FIG. 1), they may be incorporated or included within other vehicle modules or within each other, or they may be part of a larger network or system (such as engine management system, powertrain system, vehicle safety system, etc.) to name a few possibilities. In addition, these modules may include any combination of electronic processing devices, memory devices, input/output (I/O) devices, and other known components, and they may be electronically connected to other vehicle devices and modules via a suitable vehicle communications network, and can interact with them when required. It should be appreciated that engine control modules, brake control modules and steering control modules are well known in the art and are, therefore, not described here in detail. Some examples of such modules that may be particularly useful with exemplary system 10 include those that utilize drive-by-wire, brake-by-wire and steer-by-wire technologies. Vehicle safety system 10 is not limited to any particular module or module arrangement.

Again, the preceding description of exemplary vehicle safety system 10 and the drawing in FIG. 1 are only intended to illustrate one potential embodiment and the following method is not confined to use with only that system. Any number of other system arrangements, combinations and architectures, including those that differ significantly from the one shown in FIG. 1, may be used instead.

Turning now to FIG. 2, there is shown an exemplary method 100 that may be used with vehicle safety system 10 in order to detect, evaluate and/or address a potential tailgating situation. To illustrate, a driver of host vehicle 12 may not be aware that they are being tailgated by another vehicle 14, a so-called target vehicle. In this situation, method 100 may detect and evaluate the tailgating event, send a warning or an alert to the driver of the host vehicle 12 and, if so authorized, perform an automatic lane change maneuver according to standard driving etiquette. All of this may occur without the driver of the host vehicle having to look in the rear-view mirror and take their eyes off of the road in front of them. The automatic lane change maneuver is an optional feature and is not a mandatory part of method 100.

Beginning with step 110, the method gathers a tailway distance (also referred to as a tailway gap) and one or more readings that may be used to detect and/or evaluate a potential tailgating event. The collection of readings gathered in this step may vary, but according to an exemplary embodiment step 110 gathers or obtains the following readings at control module 40: a tailway distance that represents the distance between host vehicle 12 and target vehicle 14, host vehicle readings from host vehicle sensors 20-26, target vehicle readings from target vehicle sensor 32, environmental readings from environmental sensor 34, navigational readings from navigation module 36, and/or other readings or data from other sensors, components, devices, modules, systems, etc. located around the vehicle. Control module 40 may then process, analyze or otherwise evaluate these readings in order to determine if target vehicle 14 is following host vehicle 12 at an uncomfortably close distance; that is, determine if the target vehicle is tailgating the host vehicle. This determination may be impacted by vehicle operating conditions (e.g., following a host vehicle at a certain tailway distance may be appropriate at 25 m.p.h., but not at 70 m.p.h.), by environmental conditions (e.g., following a host vehicle at a certain tailway distance may be acceptable on dry asphalt, but not on icy pavement or gravel), by navigational conditions (e.g., following a host vehicle at a certain tailway distance may be appropriate on a straightaway section of the road, but not as the vehicles are entering a sharp turn), or by other factors.

As mentioned above, step 110 may monitor the area behind host vehicle 12 while the host vehicle is traveling in a forward direction by gathering various combinations of host vehicle readings from host vehicle sensors 20-26 and/or target vehicle readings from target vehicle sensor 32. Some examples of suitable readings that may be gathered include: a host vehicle speed, a target vehicle speed, a host vehicle acceleration, a target vehicle acceleration, a host vehicle size, a target vehicle size, and/or some other reading pertaining to a host or target vehicle operating condition, like the current steering status of the vehicle (e.g., is the vehicle currently engaged in a tight turn). Other types of host and target vehicle readings, as well as other vehicle operating conditions may be gathered or obtained in this step.

Step 110 may also gather various environmental readings from environmental sensor 34 and use that information when monitoring the area behind host vehicle 12. The environmental readings may include any readings or data pertaining to the outside or surrounding environment that can affect the traction or stability of the vehicle, such as those that impact road conditions. Some exemplary environmental readings include those relating to: weather conditions (e.g., whether it is raining, snowing or an ice storm), outside temperature (e.g., below freezing, above freezing), outside humidity (e.g., high humidity, low humidity, presence of fog), surrounding visibility (e.g., time of year, time of day), and road surface conditions (e.g., concrete, asphalt, gravel, dirt, etc.), to provide a few possibilities. In one particular embodiment, environmental sensor 34 provides control module 40 with environmental sensor readings for the current humidity and temperature for the surrounding atmosphere so that the method may take into account the likely presence of rain, snow or ice on the road.

In addition, step 110 may also gather navigational readings from navigation module or unit 36 and use this information when monitoring the area behind host vehicle 12 for potential tailgating events. For example, it is possible for navigation module 36 to send control module 40 navigational information regarding the current status of road that the host vehicle is on, such as how many lanes the road has, the posted speed limit of the road, whether or not there are any sharp or significant turns or other maneuvers coming up, etc. This information can then be taken into account, along with any other readings of information gathered in step 110, when detecting and/or evaluating a tailgating event. Although the nature and type of navigational readings may vary, it is possible for step 110 to gather or otherwise obtain the following road-related information: expected lane closures or lane endings, road construction, traffic conditions (e.g., light traffic ahead, heavy traffic ahead, etc.), sharp turns or forks in the road ahead, lane availability, posted speed limits, etc. In one embodiment, navigation module 36 provides control module 40 with navigational readings that include posted speed limits, number of lanes available, road status (e.g., lane closure, road construction, heavy/light traffic, etc.), and upcoming road maneuvers (e.g., sharp turn ahead, etc.), to cite a few possibilities.

As mentioned above, it is not necessary for sensors 20-36 to provide readings and information directly to control module 40; instead, these readings may be provided by or obtained from different components, modules and/or systems located around the vehicle that are already in possession of such information. For example, a stability control system, an antilock braking system (ABS), a vehicle dynamics control system, or a traction control system may provide the host vehicle readings mentioned above. In another example, environmental and/or navigational readings may be telematically provided by some type of weather- or traffic-related service or back-office facility, like a call center. Step 110 may gather or obtain other sensor readings, in addition to or in lieu of the exemplary ones described here.

Next, step 120 evaluates the various readings gathered in step 110 in order to subsequently determine if the target vehicle is driving too close to the host vehicle; that is, if the target vehicle is tailgating the host vehicle. There are a number of different ways or techniques for performing this evaluation, including establishing and using a tailway distance criterion (TDC) or warning distance. Generally speaking, the warning distance represents the distance behind host vehicle 12 at which a warning or alarm is sounded in order to inform the host vehicle driver that they are being tailgated, and it is possible for the warning distance to be a dynamic threshold. Some warning distances may be predicated on a “three-second safety” rule or the like. For example, the warning distance for when the host vehicle is traveling at 70 m.p.h. may be greater than it is for 25 m.p.h., as a greater stopping distance between the two vehicles is needed at higher vehicle speeds. The warning distance for when the host vehicle is driving on road surfaces that are icy, wet, gravely or otherwise inclement may be greater than it is for a dry road surface, like asphalt. The warning distance for a host vehicle traveling on a road full of sharp turns, speed limit changes, stop signs, traffic lights, etc. can be greater than that for a road with a long straight away section. And the warning distance for when the target vehicle is identified as a large truck may be greater than it is when the target vehicle is a small car. The preceding examples only represent some of the potential instances where the warning distance dynamically changes according to different factors, as other factors surely exist. It is possible for the warning distance to be determined using look-up tables or other data structures, to be calculated using equations, or to be derived using other techniques. It is also possible for the warning distance to be a static or predetermined distance.

Step 130 determines if a target vehicle is tailgating the host vehicle, and can do so in a variety of ways. After detecting a target vehicle 14 in the area behind the host vehicle 12 and determining both a tailway distance and a warning distance, step 130 may determine when the target vehicle is too close to the host vehicle by comparing these two distances together. If the tailway distance is greater than the warning distance, then there may be no need to alert or warn the driver as a tailgating situation does not currently exist; if, on the other hand, the tailway distance is less than or equal to the warning distance, then a tailgating event may exist and the driver of the host vehicle may need to be warned. As explained above, the method may take various conditions inside and outside of the vehicle into account by adjusting the warning distance so that it is longer during periods when a greater stopping distance is likely needed (e.g., during high speeds or slipper road conditions) and is shorter during periods when a lesser stopping distance is required. There are other ways for taking such conditions and readings into account, as method 100 is not strictly limited to adjusting a dynamic warning distance. One alternative approach is to use a static warning distance, but require that the tailway distance be less than the warning distance by some factor (e.g., some percentage, some margin of error, etc.) before issuing a warning to the driver.

It is possible for step 130 to use one or more precautionary checks before determining that the target vehicle is tailgating the host vehicle. For instance, step 130 may check the host and/or target vehicle speed to make sure that the vehicles are not simply stuck in traffic, at a stop light or in some other situation that could be mistakenly interpreted as a tailgating event. One way to perform such a check is to ensure that the host and/or target vehicle speed is greater than some low-speed threshold (e.g., 15 m.p.h.) or to consult the navigational readings from navigation module 36 before determining that the host vehicle is being tailgated. As another example of a precautionary check, step 130 may need to confirm that the tailgating event has occurred for some minimal amount of time, thereby avoiding momentary events like when the host vehicle changes lanes and is temporarily in front of another vehicle at a close distance. Step 130 may also check to see if the target vehicle is in the same lane as the host vehicle before concluding that the host vehicle is being tailgated; this can avoid situations where a target vehicle is rapidly approaching in an adjoining lane, but is not tailgating the host vehicle. Another example of a precautionary check involves the relative velocities and/or accelerations of the host and target vehicles. If the host vehicle is traveling at a greater velocity than the target vehicle and is, accordingly, pulling away from that vehicle, then a tailgating status may not be warranted. Skilled artisans will recognize that other precautionary checks may be employed and that the precautionary checks are only optional; it is not mandatory for step 130 to use such precautionary checks. If there is a tailgating event then the method proceeds to step 140; otherwise, the method loops back to step 110 for continued monitoring.

At step 140, the method sends an alert to the driver of the host vehicle that warns them of the tailgating event. There are several ways to alert the driver of this situation, including issuing one or more of the following alerts: a visual alert, an audio alert, or a tactile alert. In one embodiment, control module 40 sends an alert signal to user interface 62, which can be located in the instrument panel, the rear view mirror or some other suitable spot, that causes a visual alert or warning that the vehicle is being tailgated. The visual alert may be in the form of an indicator light, a textual message, a video image from backup camera 32 showing the target vehicle on a monitor, or some other suitable visual alert. In another embodiment, user interface 62 includes one or more audio components and control module 40 sends an alert signal to the user interface so that an audio alert, warning and/or message is played to inform the driver of the tailgating event. Examples of some suitable audible alerts include: pre-recorded audio messages informing the driver of the tailgating event, one or more chimes or any other audio indications, etc. Haptic alerts or warnings may be used as well. Again, the preceding examples represent only a few of the possibilities, as any combination of suitable visual, audio, haptic and/or other types of alerts or warnings may be used. In an exemplary embodiment, step 140 alerts the driver of the host vehicle that they are being tailgated by activating a visual warning on the rear-view mirror and issuing an audio warning in the form of a chime.

At this point, method 100 could end. However, in those embodiments where the host vehicle is equipped with certain autonomous driving capabilities, optional steps 150 and 160 may provide the driver with the option of an automatic lane change. Step 150 determines if a lane change is currently appropriate, and may consider a number of factors when doing so. For instance, step 150 may consider the current host vehicle speed and compare that to a posted speed limit for that road (this could be obtained from the navigational readings obtained previously). If the host vehicle is already traveling at or above the posted speed limit, then a lane change maneuver may not be appropriate or desirable; at which point, the method could loop back to step 110 for further monitoring. If the host vehicle speed is less than the corresponding posted speed limit, then step 150 may consult one or more other factors before determining that an automatic lane change is appropriate.

One such factor may be the available of an adjacent, slower lane. Depending on the country where the host vehicle is being driven, lanes furthest from the oncoming traffic (e.g., lanes to the right in countries where travel is on the right-side of the road, like the United States or Canada, and lanes to the left in countries where travel is on the left side of the road, such as the United Kingdom or Australia) are usually intended to be slower than those closer to the oncoming traffic lanes. Step 150 may use some combination of navigational readings, host vehicle readings and/or target vehicle readings to determine if there is in fact a slower adjacent lane and, if such a lane exists, if that lane has been unoccupied and open for some period of time. Step 150 may further check to see if there are any upcoming road features or other situations that would prevent or even discourage a lane change maneuver (e.g., presence of an upcoming sharp turn, the end or merger of a passing lane, traffic laws that prohibit lane changes at that location, presence of a stationary vehicle or vehicles on the shoulder of the road, etc.). In one embodiment, control module 40 gathers navigational readings from navigation module 36 and readings from target vehicle sensor 32, and uses this information to determine that: an adjacent lane exists, the adjacent lane has been unoccupied and clear for a minimum amount of time (e.g., at least a few seconds), and that there are no upcoming road features like a sharp turn, lane closure or other situations that would prohibit the lane change maneuver. Once step 150 ensures that a lane change is appropriate, then the method may proceed to the next step; otherwise, the method may loop back to step 110 for continued monitoring.

Step 160 then requests that the operator make a manual lane change or it performs an automatic lane change maneuver where the host vehicle is guided from a current lane to an adjacent lane. For vehicles that are equipped with certain types of autonomous driving features (e.g., Freeway Limited Ability Autonomous Driving (FLAAD) features), step 160 causes one or more control modules take over some operational control of the vehicle and automatically guide the host vehicle from the current lane to the available adjacent lane. This step may be performed according to a number of different embodiments. In one embodiment, the driver may have already granted the vehicle permission to perform the automatic lane change maneuver, so that step 160 may simply inform the driver that such a maneuver is being executed and then execute the lane change. In another embodiment, step 160 may first request permission from the driver to perform the lane change maneuver and, once such permission is granted, then automatically change lanes. According to an exemplary embodiment where permission has been given for the host vehicle to perform an automatic lane change maneuver, control module 40 communicates with engine control module 70, brake control module 80 and/or steering control module 90 so that these modules temporarily take over operational control of the vehicle and guide it from the current lane to the adjacent lane. The method may end at this step or loop back to step 110.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater or different steps than that shown here. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method for use with a vehicle safety system, comprising the steps of:
(a) providing a vehicle safety system having one or more sensing device(s) for installation on a host vehicle;
(b) monitoring an area behind the host vehicle with the sensing device(s) while the host vehicle is being driven in a forward direction;
(c) detecting a target vehicle in the area behind the host vehicle with the sensing device(s) while the host vehicle is being driven in the forward direction, and determining a tailway distance between the target vehicle and the host vehicle; and
(d) evaluating the tailway distance between the target vehicle and the host vehicle, and alerting an operator inside of the host vehicle when the target vehicle is too close.

2. The method of claim 1, wherein step (a) further comprises providing the vehicle safety system with one or more sensing device(s) in the form of short range radar sensors that are part of an existing vehicle backup system, and the short range radar sensors monitor the area behind the host vehicle while the host vehicle is being driven in the forward direction.

3. The method of claim 1, wherein step (a) further comprises providing the vehicle safety system with one or more sensing device(s) in the form of cameras that are part of an existing vehicle backup system, and the cameras monitor the area behind the host vehicle while the host vehicle is being driven in the forward direction.

4. The method of claim 1, wherein step (c) further comprises gathering one or more host vehicle readings from host vehicle sensors or target vehicle readings from target vehicle sensors; and step (d) further comprises evaluating the tailway distance and the host vehicle readings or target vehicle readings together in order to determine when the target vehicle is too close.

5. The method of claim 4, wherein step (d) evaluates at least one of the following host vehicle readings: a host vehicle speed, a target vehicle speed, a host vehicle acceleration, a target vehicle acceleration, a host vehicle size, a target vehicle size, or a host vehicle steering status.

6. The method of claim 1, wherein step (c) further comprises gathering one or more environmental readings from an environmental sensor; and step (d) further comprises evaluating the tailway distance and the environmental readings together in order to determine when the target vehicle is too close.

7. The method of claim 6, wherein step (d) evaluates at least one of the following environmental readings: a weather condition, an outside temperature, an outside humidity, a surrounding visibility, or a road surface condition.

8. The method of claim 1, wherein step (c) further comprises gathering one or more navigational readings from a navigation module; and step (d) further comprises evaluating the tailway distance and the navigational readings together in order to determine when the target vehicle is too close.

9. The method of claim 8, wherein step (d) evaluates at least one of the following navigational readings: an expected lane closure or lane ending, a road construction, a traffic condition, a sharp turn or fork in the road ahead, a lane availability, or a posted speed limit.

10. The method of claim 1, wherein step (d) further comprises evaluating the tailway distance by comparing it to a warning distance, and alerting the operator inside of the host vehicle when the tailway distance is less than or equal to the warning distance.

11. The method of claim 10, wherein the warning distance is a dynamic threshold that changes according to at least one of the following factors: a host vehicle reading, a target vehicle reading, an environmental reading, or a navigational reading.

12. The method of claim 1, wherein step (d) further comprises considering one or more of the following precautionary check(s) before determining that the target vehicle is too close: that the host vehicle is not stuck in traffic, that the target vehicle has been tailgating the host vehicle for a minimal amount of time, that the target vehicle is in the same lane as the host vehicle, or that the host vehicle is not pulling away from the target vehicle.

13. The method of claim 1, wherein step (d) further comprises alerting the operator inside of the host vehicle when the target vehicle is too close by providing at least one of the following alerts: a visual alert, an audible alert, or a tactile alert.

14. The method of claim 13, wherein step (d) alerts the operator inside of the host vehicle when the target vehicle is too close by activating a visual warning on a rear-view mirror of the host vehicle.

15. The method of claim 1, further comprising the step of:
(e) determining if a lane change is appropriate and, if it is appropriate, then performing an automatic lane change maneuver.

16. The method of claim 15, wherein step (e) further comprises determining if a lane change is appropriate by determining one or more of the following: is there an adjacent lane, is the adjacent lane clear for a lane change, or is there any upcoming road features in the adjacent lane that prevent the lane change.

17. The method of claim 16, wherein step (e) further comprises determining if the adjacent lane has been unoccupied and clear for a minimal amount of time.

18. The method of claim 15, wherein step (e) further comprises performing the automatic lane change maneuver by using at least one of the following control modules to take over certain operational control of the vehicle: an engine control module, a brake control module, or a steering control module.

19. A method for use with a vehicle safety system, comprising the steps of:
(a) determining if a target vehicle is tailgating a host vehicle while the host vehicle is being driven in a forward direction;
(b) alerting an operator that the target vehicle is tailgating the host vehicle;
(c) determining if a lane change is appropriate; and
(d) if the lane change is appropriate, then requesting that the operator make a manual lane change or performing an automatic lane change maneuver where the host vehicle is guided from a current lane to an adjacent lane.
